(19) United States
(12) Patent Application Publication
(10) Pub. No.: US 2009/0150404 A1
(43) Pub. Date: Jun. 11, 2009

(54) Method of reading filles from remote server by email

(75) Inventor: Ying-Chien Lin, Hsinchu (TW)

Correspondence Address: BACON & THOMAS, PLLC, 625 SLATERS LANE, FOURTH FLOOR, ALEXANDRIA, VA, 22314-1176, US

(73) Assignee: Alpha Networks Ins., Hsinchu (TW)

(21) Appl. No.: 11/987,942

(22) Filed: Dec. 6, 2007

(51) Int. Cl. G06F 17/30

(52) U.S. Cl. 707/10; 707/E17.032

(57) ABSTRACT

In a method of reading files from a remote server by an email, the method is applied in a network system having a remote server, a computer and the Internet. The remote server includes a database for storing files and is connected with the computer through the Internet. Users can create an email including a request instruction at the computer and send the email to the remote server for a request of reading files from the remote server. After the remote server reads the email, a file list is replied to the computer according to the request instruction. The user can create another email including a select instruction and a file location and send such email to the remote server. After the remote server receives such email, a corresponding file in the database is returned to the computer according to the select instruction and the file location.

### FIELD OF THE INVENTION

The present invention relates to a method of reading files from a remote server, and more particularly to a method of reading the files from a remote server by using an email, so that the user can read each file in the database of the remote sever by a computer anywhere and anytime without requiring an installation or a setup of additional software and equipments to effectively enhance the convenience of reading remote files.

### BACKGROUND OF THE INVENTION

As electronic technology and industry are developed rapidly in recent years, Internet related technologies have substantial breakthroughs and advancements, and Internet becomes increasingly popular, and the network transmission rate increases continuously. Thus, users can use the Internet for transmitting files in a more convenient and quicker manner. Obviously, Internet has become an indispensable and important tool to our daily life. In general, users transmit files via the Internet by the following traditional ways:

1. File Transfer Protocol (FTP) provides a function for users to set up a server and a client, so that a large quantity of files can be transmitted between the server and the client, and the server can also manage the priority right of clients for transmitting files. However, users must have FTP software before using the aforementioned application, and FTP is affected by a firewall easily which may cause a failure of the file transmission. To avoid failures of file transmissions, users must open an additional port for the FTP to transmit files, and such arrangement seriously affects the security of network transmission.

2. Virtual Private Network (VPN) provides a way for users to create a private and safe network transmission channel by VPN software and use a special encryption method on the Internet. However, the construction of VPN requires VPN software, and a complicated construction procedure that requires VPN related professional knowledge, and thus general users have to take much time to get familiar with the construction and the operating method, or have to pay extra costs to hire professionals to construct the VPN. Obviously, the construction of VPN causes tremendous inconvenience to users.

Although there is a need for users to read remote files via the Internet, the two aforementioned methods of reading remote files have drawbacks, and users are reluctant to use these methods. Furthermore, the two traditional methods of reading remote files require installing dedicated software, or else users cannot read remote files directly via a computer anywhere. Therefore, it is an important subject for manufacturers to design a novel way of reading remote files via the Internet, such that users can read remote files via the Internet by a computer in the safest manner in order to effectively enhance the convenience of reading remote files without requiring an installation or a setup of additional software and equipments.

### SUMMARY OF THE INVENTION

In view of the problems and shortcomings of the transitional ways of transmitting files via the Internet, the inventor of the present invention based on years of experience in the related industry to conduct extensive researches and experiments, and finally invented a method of reading files from a remote server by an email to effectively overcome the shortcoming that users cannot directly and safely transmit a file from anywhere through a computer.

It is a primary objective of the present invention to provide a method of reading files from a remote server by an email, and the method is applied in a network system, and the system comprises a remote server, a computer and Internet, wherein the remote server has a database for storing a plurality of files, and the remote server is connected with the computer through the Internet, and the computer is provided for users to create an email including a request instruction, so that users can send a request for reading files from the remote server. In the method, the computer can send an email to an account through the Internet after a user has created an account in the remote server and an email in the computer. After the remote server has read the email in the account, a file list is replied to the computer according to the request instruction carried in the email, wherein the file list is a list of files in the database provided for users to select the desired reading file. As long as the user has created another email at the computer, and the other email includes a select instruction and a file location of a desired file, such email will be sent to the remote server. After the remote server has received this email, the corresponding file in the database is returned in an email format to the computer and provided for the user to read the file according to the select instruction and the file location in the email, so that the user can read each file in the database of the remote sever by a computer anywhere and anytime without requiring an installation or a setup of additional software and equipments to effectively enhance the convenience of reading remote files.

Another objective of the present invention is to provide a way for users to read each file of the remote serve in an email format by the computer, such that if the computer or the remote server installs a firewall, users still can directly read the file via an email read by a port without requiring professionals to open an additional port at the computer or the remote server in order to avoid the blocking of the firewall, and thus greatly improving the convenience and security of the network transmission.

To make it easier for our examiner to understand the objective, structure, design principle and performance of the present invention, we use preferred embodiments together with the attached drawings for the detailed description of the invention as follows:

### BRIEF DESCRIPTION OF THE DRAWINGS

FIG. 1 is a schematic block diagram of a network system;

FIG. 2 is a flow chart of a preferred embodiment of the invention; and

FIG. 3 is a flow chart of another preferred embodiment of the invention.

### DETAILED DESCRIPTION OF THE PREFERRED EMBODIMENTS

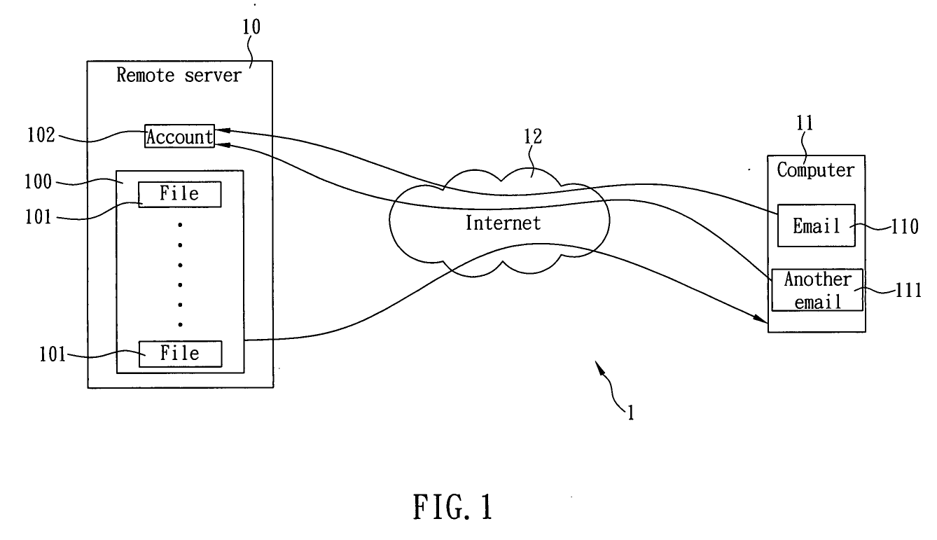

Referring to FIG. 1 for a method of reading files from a remote server by an email in accordance with the present invention, the method is applied to a network system 1, and the network system 1 comprises a remote server 10, a computer 11 and the Internet 12, wherein the remote server 10 has a database 100 for storing a plurality of files 101, and the computer 11 is connected with the remote server 10 through the Internet 12, and the computer 11 is provided for users to create an email 110, and the email 110 includes a request instruction, and the computer 11 sends out a request to the remote server 10 by the request instruction for reading the files 101.

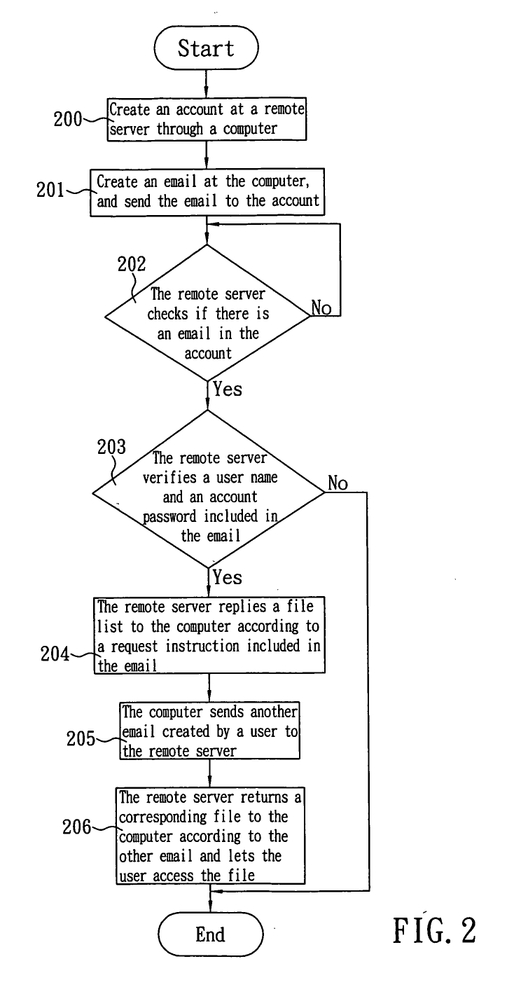

Referring to FIG. 2 for a preferred embodiment of the present invention, the method of the invention comprises the steps of:

Step (200): setting up an account 102 on the remote server 10 through the computer 11;

Step (201): creating the email 110 at the computer 11, and sending out the email 110 from the computer 11 to the account 102 through the Internet 12;

Step (202): periodically checking whether or not the account 102 contains an email 110 by the remote server 10; if yes, then go to Step (203), or else repeat Step (202);

Step (203): verifying a user name and an account password contained in the email 110 by the remote server 10; if the user name and the account password are correct, then go to Step (204), or else end the processing procedure;

Step (204): replying a file list to the computer 11 according to the request instruction carried by the email 110 after the remote server 10 has read the email 110 in the account 102, wherein the file list is a list of the files 101 in the database, and used for listing the locations of the files 101 for users to select the desired file 101, so that a user can create another email 111 at the computer 11 according to the file list, and this email 111 contains a select instruction and a file location of a user's desired file;

Step (205): sending the email 111 created by the users at the computer 11 to the remote server 10; and

Step (206): returning the corresponding file 101 in the database 100 in the format of an email to the computer 111 by the remote server 10 according to the select instruction and the file location in the email 111, such that the user can read the file 101.

Therefore, users can read each file 101 in the database 100 of the remote server 10 directly from the computer 11 anywhere and anytime without the need of installing or set up additional software and equipment to read the file, and thus making the procedure of reading each file 101 from the remote server 10 simpler and easier, and enhancing the convenience of reading the remote file 101. Since the present invention transmits each file 101 by an email format, therefore, if the computer or the remote server installs a firewall, users still can directly read the file via the email from a port without requiring a professional to open an additional port of the computer or the remote server in order to avoid the blocking of the firewall, and thus greatly enhancing the convenience and security of the network transmission.

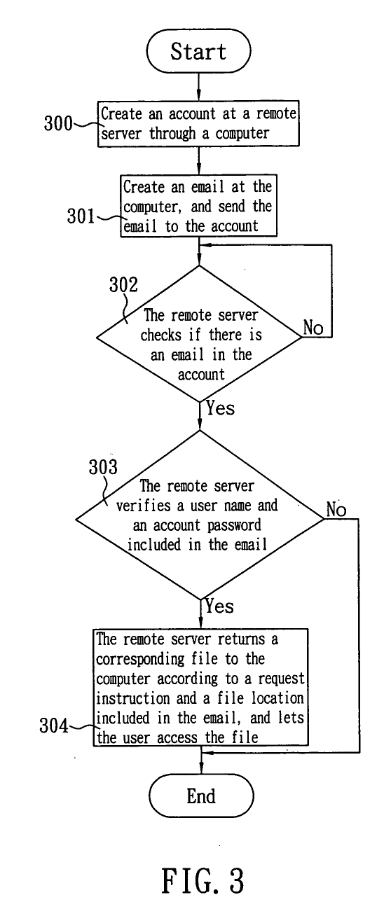

A preferred embodiment t of the present invention is described above, but the invention is not limited to such embodiment only, and another preferred embodiment as shown in FIG. 3 is used for illustrating the method of the invention, and the method comprises the steps of:

Step (300): creating an account 102 on the remote server 10 through the computer 11;

Step (301): creating the email 110 at the computer 11, wherein the email 110 includes a file location of a desired reading file in addition to the request instruction, and transmitting the email 110 to the account 102 by the computer 11 through the Internet 12;

Step (302): periodically checking whether or not the account 102 has an email 110 by the remote server 10; if yes, then go to Step (303), or else repeat Step (302);

Step (303): verifying a user name and an account password included in the email 110 by the remote server 10; if the user name and the account password are correct, then go to Step (304), or else end the processing procedure; and

Step (304): transmitting the corresponding file 101 from the database 101 to the computer 11 in an email format by the remote server 10 according to the request instruction and file location of the desired reading file to provide the file 101 to be read by the user.

After the user has set the request instruction for reading the file 101 in the email 110, the user can read the required file 101 directly through the computer 11, so as to make the overall process of reading a remote file 101 simpler and more convenient.

Embodiments of the invention are described above, but the invention is not limited to these embodiments only. In other embodiments of the invention, the step of verifying the user name and the account password contained in the email 110 by the remote server 10 can be omitted if the file 101 is a non-confidential file or a general public file. In Step (202) or (302) as shown in FIGS. 2 and 3, if the remote server 10 detects the email 110 in the account 102, Step (203) or (303) can be omitted and the procedure directly goes to Step (204) or (304), such that the remote server 10 can directly complete the steps that follow according to the request instruction included in the email 110, and users can read the required remote file 101 more quickly.

In each foregoing embodiment, the email 110 can be a pure text format (txt format) or a hypertext markup language format (html format), and the remote server 10 can be a network-attached storage (NAS). To avoid increasing the system load of the remote server 10, the request instruction in the email 110 is recorded immediately after the remote server 10 has received the email 110 sent by users, and the steps that follow are carried out, and then the email 110 is deleted to decrease the system load of the remote server 10.

While the invention has been described by means of specific embodiments, numerous modifications and variations could be made thereto by those skilled in the art without departing from the scope and spirit of the invention set forth in the claims.

What is claimed is:

1. A method of reading a file from a remote server by an email, applied in a network system, and the system comprising a remote server, a computer and the Internet, wherein the remote server includes a database for storing a plurality of files, and the computer connects the remote server through the Internet, and the computer is provided for users to create an email, and the email includes a request instruction for users to issue a request to the remote server for reading the files, and the method comprising the steps of:
transmitting the email to an account in the remote server by the computer via the Internet, after the computer has created the email;
replying a file list to the computer after the remote server has read the email in the account according to the request instruction carried in the email, wherein the file list is a list of the files in the database;
transmitting another email to the remote server by the computer via the Internet, after the computer has created the another email including a select instruction and a file location of a desired reading file; and
returning the corresponding file from the database to the computer in an email format by the remote server according to the select instruction and the file location in the another email.

2. The method of reading a file from a remote server by an email as recited in claim 1, wherein before the remote server reads the email in the account, the method further comprises the step of:
periodically checking whether or not there is an email in the account by the remote server.

3. The method of reading a file from a remote server by an email as recited in claim 2, wherein the email further comprises a user name and an account password.

4. The method of reading a file from a remote server by an email as recited in claim 3, wherein if the remote server finds an email in the account, the remote server will verify the user name and the account password in the email.

5. The method of reading a file from a remote server by an email as recited in claim 4, wherein the computer transmits the email to an account in the remote server via the Internet after the email is created at the computer, and the method further comprises the step of:
creating the account on the remote server through the computer.

6. The method of reading a file from a remote server by an email as recited in claim 5, wherein the remote server is a network-attached storage (NAS).

7. A method of reading a file from a remote server by an email, applied in a network system, and the system comprising a remote server, a computer and the Internet, wherein the remote server includes a database for storing a plurality of files, and the computer connects the remote server through the Internet, and the computer is provided for users to create an email, and the email includes a request instruction for users to issue a request to the remote server for reading the files, and the method comprising the steps of: transmitting the email to an account in the remote server by the computer via the Internet, after the computer has created the email; and
returning the corresponding file from the database to the computer in an email format by the remote server according to the select instruction and the file location in the email, after the remote server has read the email in the account.

8. The method of reading a file from a remote server by an email as recited in claim 7, wherein before the remote server reads the email in the account, the method further comprises the step of:
periodically checking whether or not there is an email in the account by the remote server.

9. The method of reading a file from a remote server by an email as recited in claim 8, wherein the email further includes a user name and an account password.

10. The method of reading a file from a remote server by an email as recited in claim 9, wherein if the remote server finds an email in the account, the user name and the account password included in the email will be verified.

11. The method of reading a file from a remote server by an email as recited in claim 10, wherein the computer transmits the email to an account in the remote server via the Internet after the email is created at the computer, and the method further comprises the step of:
creating the account on the remote server through the computer.

12. The method of reading a file from a remote server by an email as recited in claim 11, wherein the remote server is network-attached storage (NAS).
